(19) United States
(12) Patent Application Publication
(10) Pub. No.: US 2008/0110950 A1
(43) Pub. Date: May 15, 2008

(54) Paper Filing System For Vehicle Interior

(75) Inventors: James D. DOWD, Farmington Hills, MI (US); Marc A. HAYES, Plymouth, MI (US)

Correspondence Address: GROSSMAN, TUCKER, PERREAULT & PFLEGER, PLLC, 55 SOUTH COMMERICAL STREET, MANCHESTER, NH, 03101, US

(73) Assignee: COLLINS & AIKMAN PRODUCTS CO., Southfield, MI (US)

(21) Appl. No.: 11/759,504

(22) Filed: Jun. 7, 2007

Related U.S. Application Data
(60) Provisional application No. 60/804,120, filed on Jun. 7, 2006.

(51) Int. Cl. B60R 11/00

(52) U.S. Cl. 224/547

(57) ABSTRACT

A portable storage device and filing system is provided for use in a transportation vehicle. The system comprises a case which may be engaged with an interior trim component, such as an interior sidewall, and the device may appear to be part of the interior vehicle trim. The device may be accessed by articulating the sides of the case away from one another to expose the interior of the case. The interior of the case may include an expandable compartment having dividers or folders for storage and organizing of loose pieces of paper. The case may be trimmed to coordinate with the interior theme of the vehicle when stored in the vehicle.

### CROSS REFERENCE TO RELATED APPLICATIONS

This application claims the benefit of U.S. Provisional Application No. 60/804,120 filed Jun. 7, 2006, the disclosure of which is incorporated herein by reference in its entirety as if set forth fully herein.

### FIELD OF INVENTION

The present invention relates generally to the interior of transportation vehicles and, more particularly, to the storage and accessibility of loose papers therein.

### BACKGROUND OF THE INVENTION

In the everyday operation of transportation vehicles, the occupants may interact with a plethora of printed information, particularly loose slips of paper such as gasoline or food receipts, parking ticket stubs, Post-It® notes, schedules and the like. In addition, the occupants may need to access maps, vehicle information, telephone listings, addresses, etc. If stored at all, this type of information may be found in the glove compartment, console, package tray, door bin, a purse or even slipped between the seats.

People spend major portions of their day commuting or as a salesperson or “soccer mom” in their vehicles, and do not need additional distractions while driving, like trying to find loose items contained somewhere in the vehicle interior.

In order to use this type of information, the driver and passengers may try to keep the loose items within easy reach, on the seat, over the visor or in a pocket. These loose items may then clutter the vehicle interior and attract unwanted attention. In addition, the loose items may become lost, damaged or even blow out an open window.

These loose items may also need to be taken with the occupants upon departing the vehicle and may therefore have to be collected up each time and, often, not in an organized fashion.

Present storage systems in vehicles are primarily directed at organizing the space for larger discreet articles, such as bags, boxes, cups, containers, etc. and are not focused at organizing loose paper or small paper articles.

What may be needed is a device which may be integrated into an interior panel of the vehicle which may organize and store loose pieces of paper and paper items and which may provide easy access within the vehicle, as well as portability should one want to take the contents with them upon departing the vehicle. The device may thus act as a portable filing system for the interior of a vehicle.

### SUMMARY OF THE INVENTION

In one exemplary embodiment, the present invention relates to a portable storage device and filing system for use in the interior of transportation vehicles. The device may comprise a case comprising two half shells which may be hinged along one edge and capable of expanding open along the opposite edge. When opened, the device may expose a series of partitions or dividers for organizing loose papers. The device may also engage with the vehicle by sliding into an interior sidewall panel such that when in place the outer surface of the case may be substantially flush with the outer surface of the panel. In such manner, the device may appear to be part of the vehicle interior trim configuration. The case may be finished in a design and of materials that fit into the theme of the vehicle and may conceal its purpose from view.

The device may be further designed to slide on a track system into the trim panel for storage. As the case is extracted, it may be biased to open partially and expose its filing system and allow access to any stored contents. Upon extraction from the storage slot, the case may also be used as a writing surface and/or carried as a portable filing system.

The case may be integrated into the side of the center console, however, other locations in the interior of the vehicle, such as the instrument panel, door trim, side trim, quarter panel or cargo space, are contemplated.

### BRIEF DESCRIPTION OF THE DRAWINGS

These and other objects, features and advantages of the present invention will become apparent to those skilled in the art upon reference to the following written description and accompanying drawings in which:

FIG. 1 is a perspective view of an exemplary center console in a vehicle including the paper filing system of the present invention.

FIG. 2 is a perspective view of an exemplary paper filing system according to the present invention.

FIGS. 3A and 3B are cross-sectional views of the tracking system of the exemplary console and case respectively along lines 3-3 of FIG. 2.

FIG. 4 is a cross-sectional view of the exemplary case of FIG. 6A along lines 4-4.

FIGS. 5A, 5B and 5C are perspective views illustrating the use of the exemplary case according to the present invention.

FIGS. 6A and 6B illustrate two exemplary locations for storing the case of the present invention.

FIGS. 7A, 7B and 7C are perspective views illustrating the use of the exemplary case in a second storage location.

### DETAILED DESCRIPTION OF THE INVENTION

The present invention is described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly references at 10A, 10B, and so forth in subsequent embodiments. Thus, where an embodiment description uses a reference character to refer to an element, the reference character applies equally, as distinguished by alphanumeric character, to the other embodiments where the element is common.

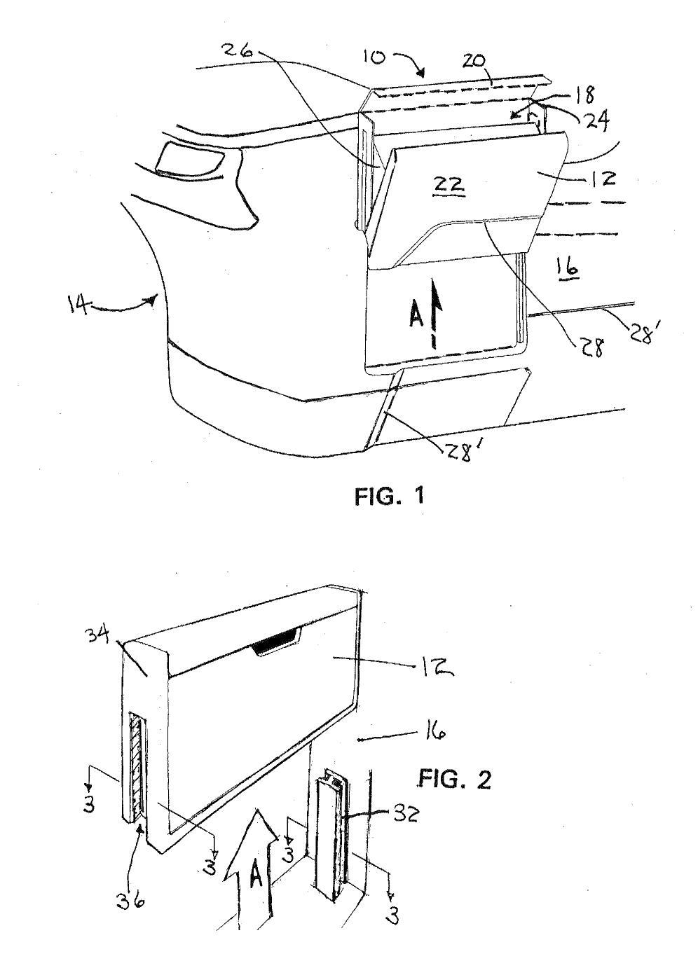

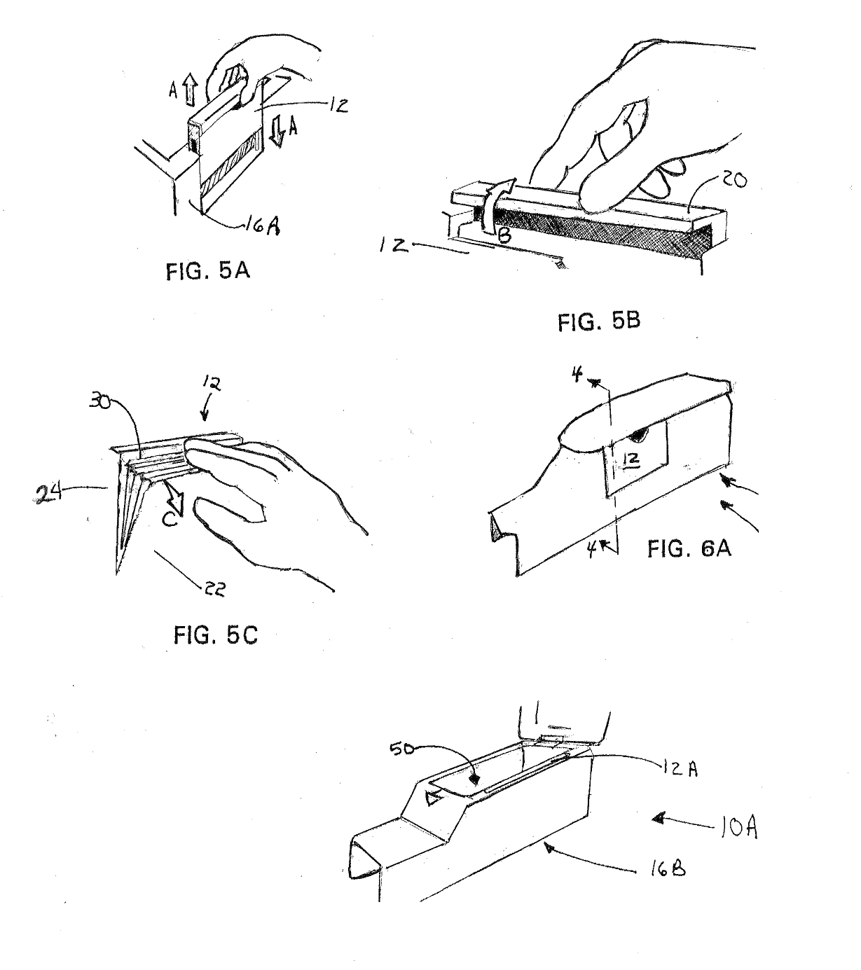

FIG. 1 illustrates an exemplary embodiment of an exemplary filing system 10 which may be inserted into a sidewall of a motor vehicle for storing loose papers and paper items. FIG. 1 illustrates the system 10 as a case or removable enclosed file 12 capable of being inserted into an exemplary center console 14. In FIG. 1 the perspective view is from the passenger's side rear seat, looking forward in-car. The case 12 may be capable of insertion into the sidewall 16 of the console 14 by sliding the case 12 downward in the opposite direction of arrow A. To extract the case 12 for portability, the case may be moved in the direction of arrow A. The case 12 is illustrated in FIG. 1 in an intermediate position with the inside 18 capable of being accessed by opening the hinged lid 20 and separating the sides 22, 24 around a hinge point 40 (see FIG. 4). A strap 26, or an accordion-like expanding file 30 which may include dividers or partitions, may be mounted on the inside 18 of the case 12 (see FIG. 5C) to limit the angle of opening.

While illustrated in FIG. 1 as built into a center console, the file system 10 of the present invention may be built into any surface of the interior of a vehicle, including, but not limited to, an instrument panel, door panel, side trim, quarter panel, seat back and cargo area. Preferably, as shown in FIG. 1, the system may be recessed into the panel to provide a substantially flush outer surface having styling, texture and color to harmonize with the adjacent panels. It may be understood herein that substantially flush contemplates that the exposed surface of the file system 10 may be recessed and/or protrude no more than 0.50 inches from the surface of the trim panel, including all values and increments between −0.50 to 0.50 inches. Reference to −0.050 inches is reference to a substantially flush but recessed condition. In FIG. 1, a style line 28 in the outer surface of side 22 of the case 12 aligns with a complementary style line 28′ in the sidewall 16 of the console 14.

FIG. 2 is a perspective view of the case 12 extracted from its storage space in the console (arrow A) and in a closed condition, ready to be carried as a storage device. The case 12 in this condition may then be turned on a side 22, 24 and into a substantially horizontal condition and used as a writing tablet. Also shown in FIG. 2 is a tracking mechanism for positioning the case 12 in its storage space and which allows the tablet to be positioned at an intermediate position, as shown in FIG. 1, (between fully inserted, FIG. 6A, and fully extracted, FIG. 2) for access as a filing system. The tracking mechanism may comprise a tongue and groove, dovetail interface or other sliding or rolling mechanism capable of positioning the case at different positions in a storage space. FIG. 2 illustrates a projecting member 32 which may have an “H” shaped cross section attached to the storage space wall, in the console 14, which can be slidably engaged with a complementary shaped recessed opening 36 which may have a “T” shaped cross section located in the end walls 34 of the case 12.

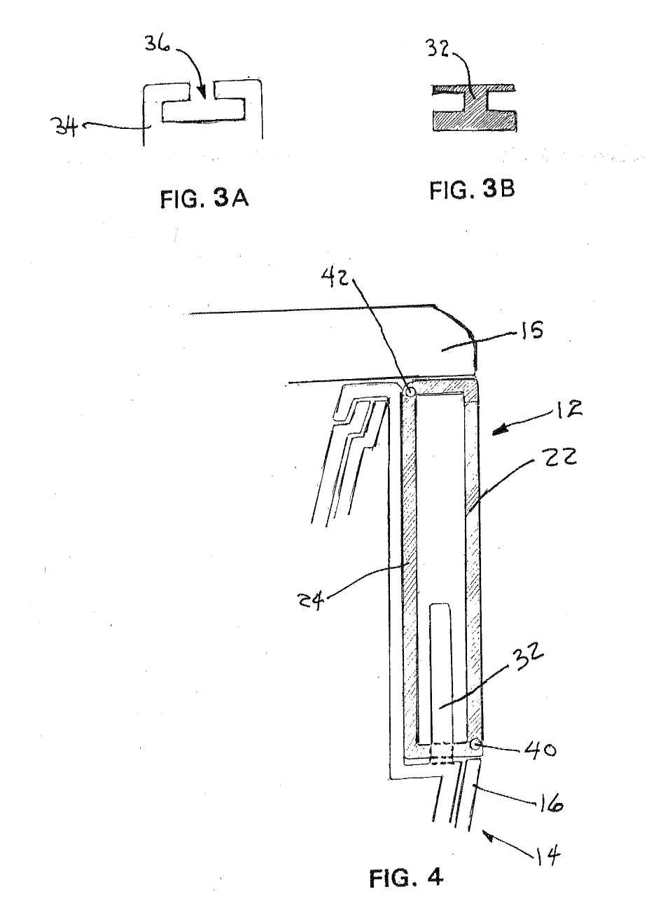

FIGS. 3A and 3B illustrate cross-sectional views of the exemplary “T” shaped opening 34 and “H” shaped member 32 taken along lines 3-3 of FIG. 2. The “H” and “T” shapes may be designed to frictionally engage and provide some resistance to sliding movement of the case 12 and promote intermediate positioning of the case 12 in the storage space for easy access.

FIG. 4 is a cross-sectional view of the case 12 of FIG. 1 fully retracted into the storage space, as shown in FIG. 6A. FIG. 4 is taken along lines 4-4 of FIG. 6A and illustrates hinging points 40 for the side walls 22, 24 of the case 12 to articulate around, as well as hinge point 42 for the lid 20. The hinges may be of any construction that allows the lid 20 and sides 22, 24 to pivotally move relative to one another. These may include, but are not limited to, an integrally formed living hinge, a separately attached living hinge, a piano hinge, a torsion hinge and an attached flexible flap of material. FIG. 4 further illustrates how the case 12 may be flush with the outer wall 16 of the exemplary console 14. The console lid 15 may overlie the case 12 and provide security for the case 12 by being capable of locking.

FIGS. 5A, 5B and 5C illustrate the use of the filing system 10 of the present invention. FIG. 5A is a perspective view of the case 12 being extracted from its storage space in the side wall of an interior trim panel 16A. FIG. 5B illustrates the hinging action (arrow B) to open the lid 20 of the case 12. FIG. 5C illustrates the articulation (arrow C) of the side walls 22, 24 to access the contents inside the case 12, in this instance, stored in an expandable set of file folders 30.

FIG. 6A illustrates an exemplary embodiment using the case 12 of the present invention to provide a filing system 10, in the outer wall 16 of a console 14.

FIG. 6B illustrates an exemplary embodiment of the filing system 10A of the present invention where a case 12A may be slidably engaged within a storage space in the bin area 50 of a console 16B.

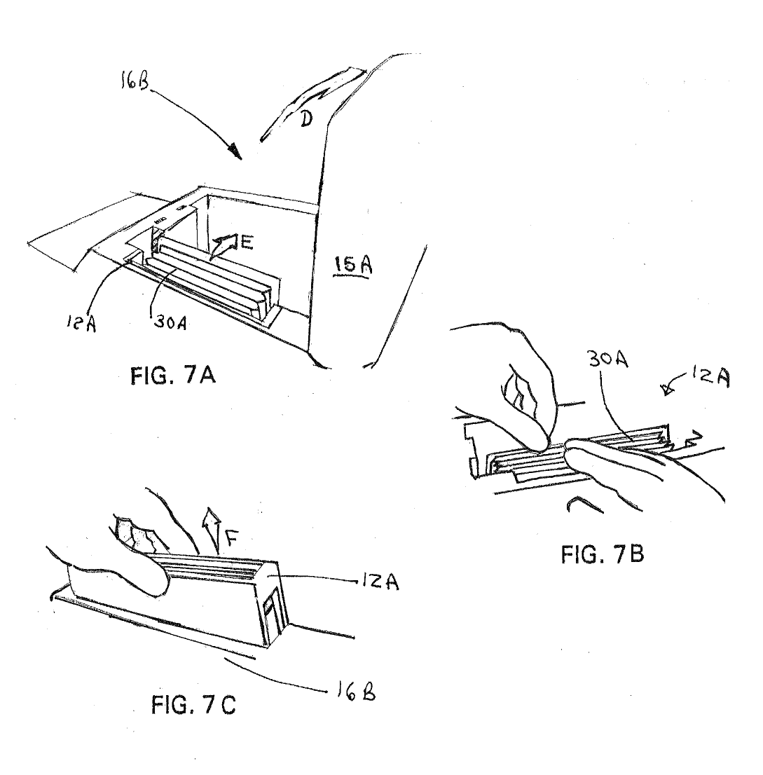

FIGS. 7A, 7B and 7C illustrate the functioning of the filing system 10A illustrated in a stored condition in FIG. 6B. FIG. 7A illustrates the console 16B with its lid 15A open (arrow D). The case 12B has been hinged open (arrow E) to allow access to the expanding file partitions/folders 30A. FIG. 7B illustrates how the expanding file/folders may be used for storage and indexing of items, particularly paper items in an organized fashion. FIG. 7C illustrates the removal (arrow F) of the case 12B for use outside the vehicle or as a writing tablet.

The case 12, 12A of the filing system of the present invention may further include such features as a hinge, latch, a lock, etc.

The description and drawings illustratively set forth the presently preferred invention embodiment. We intend the description and drawings to describe this embodiment and not to limit the scope of the invention. Obviously, it is possible to modify these embodiments. Although the present invention has been illustrated using the specific embodiments described herein, it should be apparent that changes and modifications may be entered and other related embodiments may be prepared similarly incorporating the inventive features described herein.

What is claimed is:

1. A portable storage device for the interior of a vehicle, comprising:
a removable case having a pair of opposite edges and including two half shells hinged along one of said opposite edges, the case capable of expanding open along the second of said opposite edges to expose a series of partitions; and
a tracking system for slidably engaging said removable case into a trim panel in the interior of said vehicle.

2. The portable storage device of claim 1 wherein trim panel and said removable case each have an outer exposed surface and the outer exposed surface of said removable case when slidably engaged in said trim panel lies substantially flush with the outer exposed surface of said trim panel.

3. The portable storage device of claim 1 wherein said trim panel includes one of a console, an instrument panel, a door panel, a seat back, a side trim panel, a quarter panel or a cargo area closeout panel.

4. The portable storage device of claim 1 wherein said removable case is capable of being positioned at an intermediate position in said tracking system and opened to expose its contents.

5. The portable storage device of claim 1 wherein said removable case further includes a strap to limit the amount of expansion of said two half shells.

6. The portable storage device of claim 1 wherein said removable case includes a plurality of partitions.

7. The portable storage device of claim 2 wherein said outer exposed surface of said removable case when slidably engaged in said trim panel is recessed no more than about 0.50 inches or protrudes no more than about 0.50 inches from the outer exposed surface of said trim panel.

8. A method of filing paper and other media in a vehicle, comprising:
providing a trim panel in said vehicle having an outer surface;
providing a removable case having a pair of opposite edges and including two half shells hinged along one of said opposite edges, the case capable of expanding open along the second of said opposite edges, one of said half shells providing an exposed surface when engaged to said trim panel; and
providing a tracking system for said removable case;
slidably engaging said removable case into said trim panel in the interior of said vehicle wherein said exposed surface of said removable case is substantially flush with said trim panel outer surface.

9. A portable filing system device capable of engaging an interior trim panel of a vehicle, comprising:
a removable case having a pair of opposite edges and including two half shells hinged along one of said opposite edges, the case capable of expanding open along the second of said opposite edges, one of said half shells providing an exposed surface when engaged to said trim panel; and
a tracking system for slidably engaging said removable case into a trim panel in the interior of said vehicle, wherein said exposed surface of said removable case is substantially flush with said trim panel surface

10. A portable filing system device according to claim 9 wherein said tracking system comprises the following:
a pair of opposite ends on said removable case including recessed openings for slidably engaging said trim panel;
said trim panel including a track which engages said openings in said opposite ends of said removable case and wherein said opposite ends intersect said opposite edges of said removable case.

11. The portable filing system device of claim 9 wherein said outer exposed surface of said removable case when slidably engaged in said trim panel is recessed no more than about 0.50 inches or protrudes no more than about 0.50 inches from the outer exposed surface of said trim panel.
